(19) United States
(12) Patent Application Publication
(10) Pub. No.: US 2016/0096924 A1
(43) Pub. Date: Apr. 7, 2016

(54) Polyamide Resin, Method for Preparing the Same, and Molded Article Including the Same

(71) Applicant: SAMSUNG SDI CO., LTD., Yongin-si (KR)

(72) Inventors: Jin Kyu KIM, Uiwang-si (KR); So Young KWON, Uiwang-si (KR); Young Sub JIN, Uiwang-si (KR); Joon Sung KIM, Uiwang-si (KR); Su Yeong SON, Uiwang-si (KR); Ki Yon LEE, Uiwang-si (KR); Sang Kyun IM, Uiwang-si (KR); Suk Min JUN, Uiwang-si (KR)

(21) Appl. No.: 14/598,506

(22) Filed: Jan. 16, 2015

(30) Foreign Application Priority Data
Oct. 1, 2014 (KR) 10-2014-0132665

(51) Int. Cl. C08G 69/30

(52) U.S. Cl. CPC C08G 69/30

(57) ABSTRACT

A polyamide resin is a polymer of an adipic acid-containing dicarboxylic acid component and an m-xylenediamine-containing diamine component, wherein the polymer includes about 100 ppm or less of phosphorus and about 100 ppm or less of sodium (Na), and has a gel content of about 0.5% or less as measured on a specimen prepared by melting about 10 g of the polymer at about 260° C., maintaining the molten polymer for about 30 minutes, and then cooling the molten polymer to room temperature. The polyamide resin can exhibit excellent heat resistance and can reduce or prevent gel generation upon polymerization or molding.

### CROSS-REFERENCE TO RELATED APPLICATION

This application claims priority under 35 USC Section 119 to and the benefit of Korean Patent Application 10-2014-0132665, filed Oct. 1, 2014, the entire disclosure of which is incorporated herein by reference.

### FIELD OF THE INVENTION

The present invention relates to a polyamide resin, a method for preparing the same, and a molded article including the same.

### BACKGROUND

High heat resistant polyamide (nylon) resins have a semi-crystalline structure and thus have significantly better heat resistance than general nylon. Thus, high heat resistant polyamide resin is widely used as a material for LED reflectors, connectors, automobiles and the like, which require high heat resistance. In addition, polyamide resins, such as poly(m-xylene adipamide) (MXD6), and the like, are also widely used as packaging materials for food, PET bottle packaging materials and the like due to excellent heat resistance and gas barrier properties thereof.

Generally, a polyamide resin can be obtained by polycondensation of a salt or low-order condensate formed of a dicarboxylic acid, a diamine and the like by heating under melting conditions.

However, a polyamide resin prepared by a typical method can suffer from gelation due to high temperature upon melt polymerization and can entail gel generation due to residual catalyst when molded (extruded or the like) into a molded article such as a film and the like. This can cause defects to an external appearance of the molded article, such as pinholes, fisheyes and the like, and can significant deteriorate workability.

Therefore, there is a need for a high heat resistant polyamide resin which can reduce or prevent gel generation and the like with minimal or no deterioration in properties such as heat resistance and the like.

### SUMMARY

The present invention provides a highly heat resistant polyamide resin which can exhibit excellent heat resistance and can reduce or prevent gel generation upon polymerization or molding, a method for preparing the polyamide resin, and a molded article including the same.

Exemplary embodiments of the invention include a polyamide resin that is a polymer of an adipic acid-containing dicarboxylic acid component and an m-xylenediamine-containing diamine component, wherein the polymer includes about 100 ppm or less of phosphorus and about 100 ppm or less of sodium (Na), and has a gel content of about 0.5% or less as measured on a specimen prepared by melting about 10 g of the polymer at about 260° C., followed by maintaining the molten polymer for about 30 minutes, and then cooling the molten polymer to room temperature.

In exemplary embodiments, the polyamide resin has a water vapor transmission rate (WVTR) of about 0.5 g·mm/m²·day to about 3.0 g·mm/m²·day, as measured in accordance with ASTM F1249, and an oxygen transmission rate (OTR) of about 0.1 cc·mm/m²·day to about 1.0 cc·mm/m²·day, as measured in accordance with ASTM D3985.

In exemplary embodiments, the polyamide resin may have an end group encapsulated with an end capping agent including at least one of an aliphatic carboxylic acid and an aromatic carboxylic acid.

Other embodiments of the present invention relate to a method for preparing the polyamide resin as set forth above. The method includes: preparing a solution-state prepolymer by condensation polymerization of an adipic acid-containing dicarboxylic acid component and an m-xylenediamine-containing diamine component at a temperature of about 200° C. to about 300° C. and at a pressure of about 10 bar to about 40 bar; forming prepolymer particles by removing a solvent from the solution-state prepolymer by spraying the solution-state prepolymer into a flash evaporator at a temperature of about 15° C. to about 30° C. and at a pressure of about 0 bar to about 3 bar; and performing solid state polymerization of the prepolymer particles.

In exemplary embodiments, condensation polymerization may be performed in the presence of about 0.05 parts by weight or less of a phosphorus catalyst based on about 100 parts by weight of the dicarboxylic acid component and the diamine component.

In exemplary embodiments, the flash evaporator may include a nozzle at a lower side or section thereof, and the solution-state prepolymer may be sprayed upwards into the flash evaporator through the nozzle.

In exemplary embodiments, the solution-state prepolymer may have an intrinsic viscosity of about 0.05 dL/g to about 0.25 dL/g.

In exemplary embodiments, the solution-state prepolymer may be sprayed at a rate of about 10 m/sec to about 70 m/sec.

In exemplary embodiments, the flash evaporator may have a height of about 3 m to about 30 m, and a volume about 1 m³ to about 20 m³.

In exemplary embodiments, the prepolymer particles may have an intrinsic viscosity of about 0.05 dL/g to about 0.25 dL/g, and a weight average molecular weight of about 500 g/mol to about 3,000 g/mol.

In exemplary embodiments, solid state polymerization may be performed by heating the prepolymer particles to a temperature of about 150° C. to about 280° C.

Exemplary embodiments of the present invention also relate to a molded article formed from the polyamide resin as set forth above.

### BRIEF DESCRIPTION OF THE DRAWINGS

FIG. 1 is a schematic diagram of a flash evaporator used in a method for preparing a polyamide resin according to one embodiment of the present invention.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

According to exemplary embodiments of the invention, a polyamide resin is a polymer of an adipic acid-containing dicarboxylic acid component and an m-xylenediamine-containing diamine component, wherein the polymer includes about 100 ppm or less of phosphorus and about 100 ppm or less of sodium (Na), and has a gel content of about 0.5% or less as measured on a specimen prepared by melting about 10 g of the polymer at about 260° C., maintaining the molten polymer for about 30 minutes, and then cooling the molten polymer to room temperature.

As used herein, terms such as “dicarboxylic acid (component)” and derivatives thereof include dicarboxylic acids, alkyl esters thereof (C₁ to C₄ lower alkyl esters such as monomethyl, monoethyl, dimethyl, diethyl, dibutyl esters, and the like), acid anhydrides thereof and the like, and mixtures thereof, and form a dicarboxylic acid moiety through reaction with a diamine (component). In addition, as used herein, terms such as “dicarboxylic acid moiety” and “diamine moiety” refer to residues which remain after removal of hydrogen atoms, hydroxyl groups and/or alkoxy groups when the dicarboxylic acid (component) and the diamine (component) are polymerized, respectively.

(A) Dicarboxylic Acid Component

According to the present invention, the dicarboxylic acid component may include about 50 mol % to about 100 mol %, for example, about 60 mol % to about 100 mol % of adipic acid, and optionally about 50 mol % or less, for example, optionally about 40 mol % or less of a dicarboxylic acid that is different from adipic acid. Within this range, the polyamide resin can exhibit excellent heat resistance and/or reduce or prevent gel generation upon polymerization and/or molding.

In some embodiments, the dicarboxylic acid component may include adipic acid in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 mol %. Further, according to some embodiments of the present invention, the amount of adipic acid can be in a range from about any of the foregoing amounts to about any other of the foregoing amounts.

In some embodiments, the dicarboxylic acid component may include the dicarboxylic acid that is different from adipic acid in an amount of 0 (the dicarboxylic acid that is different from adipic acid is not present), about 0 (the dicarboxylic acid that is different from adipic acid is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the dicarboxylic acid that is different from adipic acid can be in a range from about any of the foregoing amounts to about any other of the foregoing amounts.

Examples of the dicarboxylic acid that is different from adipic acid may include without limitation: aliphatic dicarboxylic acids such as malonic acid, dimethyl malonic acid, succinic acid, glutaric acid, pimelic acid, 2,2-dimethyl glutaric acid, 3,3-diethyl succinic acid, suberic acid, azelaic acid, sebacic acid, undecane diacid, dodecane diacid, and the like; alicyclic dicarboxylic acids such as 1,4-cyclohexanedicarboxylic acid, 1,3-cyclopentanedicarboxylic acid, and the like; aromatic dicarboxylic acids such as terephthalic acid, isophthalic acid, 2,6-naphthalenedicarboxylic acid, 2,7-naphthalenedicarboxylic acid, 1,4-naphthalenedicarboxylic acid, 1,4-phenylenedioxydiacetic acid, 1,3-phenylenedioxydiacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, and the like; and mixtures thereof.

(B) Diamine Component

According to the present invention, the diamine component may include about 50 mol % to about 100 mol %, for example, about 60 mol % to about 100 mol % of m-xylenediamine, and optionally about 50 mol % or less, for example, optionally about 40 mol % or less of a diamine that is different from m-xylenediamine Within this range, the polyamide resin can exhibit excellent heat resistance and/or can reduce or prevent gel generation upon polymerization and/or molding.

In some embodiments, the diamine component may include m-xylenediamine in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 mol %. Further, according to some embodiments of the present invention, the amount of m-xylenediamine can be in a range from about any of the foregoing amounts to about any other of the foregoing amounts.

In some embodiments, the diamine component may include the diamine that is different from m-xylenediamine in an amount of 0 (the diamine that is different from m-xylenediamine is not present), about 0 (the diamine that is different from m-xylenediamine is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the diamine that is different from m-xylenediamine can be in a range from about any of the foregoing amounts to about any other of the foregoing amounts.

Examples of the diamine that is different from m-xylenediamine may include without limitation: aliphatic alkylenediamines such as ethylenediamine, propanediamine, 1,4-butanediamine, 1,6-hexanediamine (hexamethylenediamine), 1,7-heptanediamine, 1,8-octanediamine, 1,9-nonanediamine, 1,10-decanediamine, 1,11-undecanediamine, 1,12-dodecanediamine, 2-methyl-1,5-pentanediamine, 3-methyl-1,5 -pentanediamine, 2,2,4-trimethyl-1,6-hexanediamine, 2,4,4-trimethyl-1,6-hexanediamine, 2-methyl-1,8-octanediamine, 5-methyl-1,9-nonanediamine, and the like; alicyclic diamines such as cyclohexanediamine, methylcyclohexanediamine, isophorone diamine, bis(4-aminocyclohexyl)methane, 1,3-bisaminomethylcyclohexane, 1,4-bisaminomethylcyclohexane, norbornane dimethaneamine, tricyclodecane dimethaneamine, and the like; aromatic diamines such as o-xylenediamine, p-xylenediamine, p-phenylenediamine, m-phenylenediamine, 4,4′-diaminodiphenylsulfone, 4,4′-diaminodiphenyl ether, and the like; and mixtures thereof.

According to the present invention, a molar ratio of the (A) dicarboxylic acid component to the (B) diamine component ((A):(B)) in the polyamide resin may range from about 1:0.95 to about 1:1.15, for example, from about 1:0.98 to about 1:1.10. Within this range, the polyamide resin can prevent or minimize deterioration in properties due to unreacted monomers.

In one embodiment, the polyamide resin may have an end group encapsulated with an end capping agent including an aliphatic carboxylic acid and/or an aromatic carboxylic acid. Examples of the end capping agent may include without limitation acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, α-naphthalenecarboxylic acid, β-naphthalenecarboxylie acid, methylnaphthalene carboxylic acid, and the like, and mixtures thereof.

The end capping agent may be present in an amount of, for example, about 0.01 parts by mole to about 5 parts by mole, for example, about 0.1 parts by mole to about 3 parts by mole, based on about 100 parts by mole of the dicarboxylic acid component and the diamine component. Within this range, the prepared polymer resin can exhibit excellent heat stability with minimal or no gel formation upon preparation thereof.

According to the present invention, the polyamide resin may be prepared by a method including: preparing a solution-state prepolymer by condensation polymerization of an adipic acid-containing dicarboxylic acid component and an m-xylenediamine-containing diamine component at a temperature of about 200° C. to about 300° C. and at a pressure of about 10 bar to about 40 bar; forming prepolymer particles by removing a solvent from the solution-state prepolymer by spraying the solution-state prepolymer into a flash evaporator at a temperature of about 15° C. to about 30° C. and at a pressure of about 0 bar to about 3 bar; and performing solid state polymerization of the prepolymer particles.

The solution-state prepolymer may be obtained by typical condensation polymerization. Although the solution-state prepolymer may vary with the dicarboxylic acid component and the diamine component which are used, the solution-state prepolymer may be obtained through reaction of monomers (dicarboxylic acid component and diamine component) at a temperature of about 200° C. to about 300° C., for example, about 200° C. to about 250° C. and at a pressure of about 10 bar to about 40 bar, for example, about 15 bar to about 35 bar, and as another example about 15 bar to about 30 bar. The solution-state prepolymer may be prepared in the form of a solution, which includes the prepolymer obtained by condensation polymerization of the monomers, for example, in a molar ratio of about 1:0.95 to about 1:1.15 (dicarboxylic acid component:diamine component) and a solvent such as water and the like, without being limited thereto.

In exemplary embodiments, condensation polymerization may be performed in the presence of a phosphorus catalyst. Examples of the phosphorus catalyst may include without limitation phosphoric acid, phosphorous acid, hypophosphorous acid, salts or derivatives thereof, and the like, and mixtures thereof. In exemplary embodiments, the phosphorus catalyst may include phosphoric acid, phosphorous acid, hypophosphorous acid, sodium hypophosphite, sodium hypophosphinate, and the like, and mixtures thereof. The phosphorus catalyst may be optionally added in an amount of about 0.1 parts by weight or less, for example, about 0.05 parts by weight or less, based on about 100 parts by weight of the dicarboxylic acid component and the diamine component. For example, the phosphorus catalyst may not be present (the amount of phosphorus catalyst is 0 parts by weight), or the phosphorus catalyst may be present in an amount of greater than 0 parts by weight to about 0.1 parts by weight. Within this range, the polyamide resin can reduce or prevent gel generation upon polymerization and molding thereof.

In exemplary embodiments, the solution-state prepolymer may have an intrinsic viscosity of about 0.05 dL/g to about 0.25 dL/g, for example, about 0.10 dL/g to about 0.20 dL/g. The intrinsic viscosity is measured at about 25° C. using an Ubbelohde viscometer after the prepolymer is dissolved to a concentration of about 0.5 g/dL in concentrated sulfuric acid (about 98%).

In addition, although a solvent included in the solution-state prepolymer may vary with the used monomers, examples of the solvent may include without limitation water, organic solvents (alcohols) such as methanol, ethanol, isopropyl alcohol and the like, and the like, and mixtures thereof.

In exemplary embodiments, the solution-state prepolymer is sprayed into a flash evaporator, and the sprayed solution-state prepolymer forms prepolymer particles (granules) by removing (flashing) the solvent from the prepolymer in the flash evaporator at a temperature of about 15° C. to about 30° C., for example, about 18° C. to about 28° C. and at a pressure of about 0 bar to about 3 bar, for example, about 0.5 bar to about 2.0 bar, and as another example about 1.0 bar to about 1.5 bar (reduced or atmospheric pressure conditions). If the temperature of the flash evaporator is higher than about 30° C., there is a concern that the prepolymer particles can be discolored, melted, carbonized or decomposed, and if the temperature of the flash evaporator is lower than about 15° C., there is a concern that the solvent is not sufficiently removed. If the internal pressure of the flash evaporator is higher than about 3 bar, there is a concern that the solvent is not sufficiently removed from the solution-state prepolymer, and if the internal pressure of the flash evaporator is lower than about 0 bar, there is a concern that the prepolymer can suffer from discoloration due to inflow of oxygen and the like.

In exemplary embodiments, the solution-state prepolymer may be sprayed at a rate of about 10 m/sec to about 70 m/sec, for example, about 15 m/sec to about 60 m/sec, and as another example about 20 m/sec to about 50 m/sec. Within this range, time for solvent removal and cooling can be sufficiently secured.

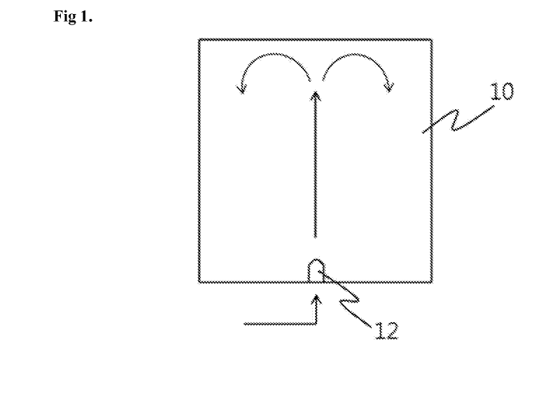

FIG. 1 is a schematic diagram of a flash evaporator used in a method for preparing a polyamide resin according to one embodiment of the present invention. As shown in FIG. 1, a flash evaporator 10 may include a nozzle 12 at a lower side thereof and may perform bottom-up type spraying of the solution-state prepolymer through the nozzle 12. When the flash evaporator 10 is used, since the solution-state prepolymer is sprayed upwards, the prepolymer particles can have sufficient cooling time.

In exemplary embodiments, the flash evaporator 10 may have various shapes, such as a cylindrical shape, a square shape, a rectangular shape, and the like. In addition, the flash evaporator 10 may have a height of about 3 m to about 30 m, for example, about 3 m to about 10 m, and a volume of about 1 m³ to about 20 m³, for example, about 1 m³ to about 10 m³. Within this range, time for solvent removal and cooling can be sufficiently secured.

In exemplary embodiments, the prepolymer particles may have a wet cake shape in which a low-order polymer that has various sizes (for example, about 1 nm to about 50 mm) and various shapes, such as particles, granules, powder, chips and the like, and is subjected to the flash process as set forth above includes about 1% by weight (wt %) to about 15 wt % of water or an organic solvent, without being limited thereto. For example, the prepolymer particles may be a polymer having an intrinsic viscosity (IV) of about 0.05 dL/g to about 0.25 dL/g, for example, about 0.10 dL/g to about 0.20 dL/g, as measured at about 25° C. using an Ubbelohde viscometer after the prepolymer particles are dissolved to a concentration of about 0.5 g/dl in a concentrated sulfuric acid solution (about 98%).

In addition, the prepolymer particles may have a weight average molecular weight of about 500 g/mol to about 3,000 g/mol as measured by gel permeation chromatography (GPC), without being limited thereto. For example, the prepolymer particles may have a weight average molecular weight of about 1,000 g/mol to about 1,500 g/mol.

In exemplary embodiments, solid state polymerization (SSP) may be performed by heating the prepolymer particles to a temperature of about 150° C. to about 280° C., for example, about 180° C. to about 250° C. in a vacuum or in the presence of an inert gas such as nitrogen, argon and the like. Within this range, the copolymerized polyamide resin having a weight average molecular weight of about 5,000 g/mol to about 50,000 g/mol can be obtained.

In exemplary embodiments, when the solution-state prepolymer is prepared, the end capping agent may be used in the amount as set forth above, and viscosity and molecular weight of the prepared polyamide resin may also be adjusted by adjustment of the amount of the end capping agent.

According to the present invention, the polyamide resin can be prepared by a flash process without use of a catalyst or in the presence of a small amount of a catalyst. In the overall polymer (polyamide resin), phosphorus from the phosphorus catalyst and the like may be optionally present in an amount of about 100 ppm or less, for example, about 90 ppm or less, and sodium (Na) may be optionally present in an amount of about 100 ppm or less, for example, about 90 ppm or less.

In some embodiments, the polyamide resin may include phosphorus in an amount of 0 (phosphorus is not present), about 0 (phosphorus is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 ppm. Further, according to some embodiments of the present invention, the amount of phosphorus can be in a range from about any of the foregoing amounts to about any other of the foregoing amounts.

In some embodiments, the polyamide resin may include sodium in an amount of 0 (sodium is not present), about 0 (sodium is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 ppm. Further, according to some embodiments of the present invention, the amount of sodium can be in a range from about any of the foregoing amounts to about any other of the foregoing amounts.

Within these ranges, the polyamide resin may have a gel content of about 0.5% or less, for example, about 0.01% to about 0.3%, as measured on a specimen prepared by melting about 10 g of the polyamide resin at about 260° C., maintaining the molten polymer for about 30 minutes, and then cooling the molten polyamide resin to room temperature.

In one embodiment, the polyamide resin may have a water vapor transmission rate (WVTR) of about 0.5 g·mm/m²·day to about 3.0 g·mm/m²·day, for example, about 1.0 g·mm/m²·day to about 2.5 g·mm/m²·day, as measured on a 50 μm thick specimen in accordance with ASTM F1249, and an oxygen transmission rate (OTR) of about 0.1 cc·mm/m²·day to about 1.0 cc·mm/m²·day, for example, about 0.3 cc·mm/m²·day to about 0.8 cc·mm/m²·day, as measured on a 50 μm thick specimen in accordance with ASTM D3985.

In exemplary embodiments, the polyamide resin may have a glass transition temperature of about 80° C. to about 120° C., for example, about 85° C. to about 100° C., and a melting temperature of about 220° C. to about 240° C., for example, about 230° C. to about 235° C. Within this range, the polyamide resin can exhibit excellent heat resistance, moldability (processability), and the like.

According to the present invention, a molded article is produced from the copolymerized polyamide resin as set forth above. For example, the copolymerized polyamide resin may be used for films for food packaging, containers and the like, which require heat resistance, melt processability and the like, without being limited thereto. The molded article can be easily formed by those skilled in the art.

Hereinafter, the present invention will be described in more detail with reference to the following examples. It should be understood that these examples are provided for illustration only and are not to be construed in any way as limiting the present invention.

### EXAMPLES

### Example 1

### Preparation of Polyamide Resin

In an autoclave, adipic acid (AA) as a dicarboxylic acid component and m-xylenediamine (MXDA) as a diamine component are placed in a molar ratio of 1:1, followed by adding 0.02 parts by weight of sodium hypophosphite monohydrate (SHM) as a phosphorus catalyst and 38 parts by weight of water. Then, the autoclave is filled with nitrogen. Next, these components are stirred at 210° C. for 60 minutes, heated to 230° C. for 1 hour, and then subjected to reaction at a pressure of 20 bar to 30 bar for 1 hour, thereby preparing a solution-state prepolymer. Next, the solution-state prepolymer is sprayed upwards at a rate of 40 m/sec through a nozzle placed at a lower side of a flash evaporator (internal temperature: 25° C., internal pressure: 0 bar to 2 bar, cylindrical shape, height: 5 m, volume: 4 m³, see FIG. 1) to flash a solvent (water) from the prepolymer, thereby preparing prepolymer particles. The prepared prepolymer particles are introduced into a tumbler-shaped reactor and subjected to solid state polymerization at 190° C. for 5 hours. Next, the resulting resin is slowly cooled to room temperature, thereby preparing a polyamide resin.

### Example 2

### Preparation of Polyamide Resin

A polyamide resin is prepared in the same manner as in Example 1 except that 0.01 parts by weight of the phosphorus catalyst is used instead of 0.02 parts by weight.

### Example 3

### Preparation of Polyamide Resin

A polyamide resin is prepared in the same manner as in Example 1 except that the phosphorus catalyst is not used.

### Comparative Example 1

### Preparation of Polyamide Resin

Adipic acid (AA) as a dicarboxylic acid component is placed in an autoclave, followed by dissolution at 160° C. Next, 0.02 parts by weight of sodium hypophosphite monohydrate (SHM) as a phosphorus catalyst based on 100 parts by weight of the dicarboxylic acid component is added to the autoclave, which in turn is filled with nitrogen. Next, the resulting solution is heated to 220° C., and m-xylenediamine (MXDA) is added as a diamine component in a molar ratio thereof to the dicarboxylic acid component of 1:1. Next, water is removed from the solution by heating the solution to 245° C., followed by maintaining the resulting material at a melting point or higher of a polyamide resin (about 260° C.), thereby preparing a molten polyamide resin.

### Comparative Example 2

### Preparation of Polyamide Resin

A polyamide resin is prepared in the same manner as in Comparative Example 1 except that 0.01 parts by weight of the phosphorus catalyst is used instead of 0.02 parts by weight.

### Comparative Example 3

### Preparation of Polyamide Resin

A polyamide resin is prepared in the same manner as in Comparative Example 1 except that the phosphorus catalyst is not used.

### Comparative Example 4

### Preparation of Polyamide Resin

A polyamide resin is prepared in the same manner as in Comparative Example 1 except that 0.1 parts by weight of the phosphorus catalyst is used instead of 0.02 parts by weight.

Property Evaluation

(1) Melting temperature and Glass transition temperature (unit: ° C.): Melting temperature, crystallization temperature and glass transition temperature are measured on each of the polyamide resins obtained after solid state polymerization in the Examples and Comparative Examples using a differential scanning calorimeter (DSC). The DSC is a Q20 instrument (TA Co., Ltd.). For measurement of crystallization temperature, a 5 mg to 10 mg of specimen is dried (to 3,000 ppm or less of moisture) at 80° C. for 4 hours in a vacuum, heated from 30° C. to 400° C. at a rate of 10° C./min in a nitrogen atmosphere, and then left at 400° C. for 1 minute. Then, the specimen is cooled at a rate of 10° C./min to obtain an exothermic peak, from which crystallization temperature is measured. Further, glass transition temperature and melting temperature are measured from transition temperature and a maximum point of an endothermic peak obtained while the specimen is heated to 400° C. at a rate of 10° C./min (2nd scan) after the specimen is maintained at 30° C. for 1 minute after measurement of the crystallization temperature, respectively.

(2) Intrinsic viscosity (unit: dL/g): The prepared polyamide resin is dissolved to a concentration of 0.5 g/dl in a 98% sulfuric acid solution, followed by measurement of intrinsic viscosity at 25° C. using an Ubbelohde viscometer.

(3) Water vapor transmission rate (WVTR, unit: g·mm/m²·day): Water vapor transmission rate is measured on a 50 μm thick specimen in accordance with ASTM F1249 using a water vapor transmission rate measuring apparatus (model: Permatran W 3/61, Mocon Inc.).

(4) Oxygen transmission rate (OTR, unit: cc·mm/m²·day): Oxygen transmission rate is measured on a 50 μm thick specimen in accordance with ASTM D3985 using an oxygen transmission rate measuring apparatus (model: OX-TRAN 2/21, Mocon Inc.).

(5) Gel content (unit: %): Gel content is calculated by Equation 1:

Gel content (%)=[W₁/W₀]×100

wherein W₀ is a weight of a specimen (10 g) prepared by melting 10 g of the prepared polyamide resin at 260° C., maintaining the molten polymer for 30 minutes, and then cooling the resin to room temperature; and W₁ is a weight of a filtered material (gel) obtained by dissolving the specimen in 100 mL of hexafluoroisopropanol (HFIP), filtering the solution through a filter paper in a vacuum oven at 80° C. to obtain a material, and drying the material for 5 hours in a vacuum of 10 torr or less.

(6) Amounts of phosphorus and sodium (unit: ppm): An amount of each of phosphorus and sodium is measured by the following experimental procedure using an ICP-OES apparatus (model: OPTIMA 7300DV, Perkin-Elmer Co., Ltd.).

Experimental Procedure

1) The prepared polyamide resin is cut into small specimens of 0.1 g or less using a knife, a pair of scissors, and the like.

2) After weighing 0.5 g of the specimens to a level of 0.1 mg, the weighed specimens are moved into a 150 mL glass beaker.

3) The beaker containing the specimens is put on a hot plate, and 5 mL of concentrated sulfuric acid is supplied into the beaker, followed by heating the beaker to 200° C. to 250° C. for 15 minutes or more such that organic materials are carbonized.

4) The beaker is removed from the hot plate and cooled to room temperature (25° C.).

5) Hydrogen peroxide is injected in an amount of 1 mL each time into the beaker until the organic materials are decomposed through oxidation of the carbonized specimens. Hydrogen peroxide is injected until the specimens have an amorphous shape.

6) Next, 10 mL of nitric acid (nitric acid solution at a volume fraction of 50%) is injected into the beaker, followed by heating the beaker to 100° C. for 10 minutes.

7) After completion of heating, the beaker is cooled to room temperature (25° C.), and the amount of each of phosphorus and sodium of the resulting material is measured using an ICP-OES tester (model: OPTIMA 7300DV, Perkin-Elmer Co., Ltd.).

TABLE 1

| | Example | | | Comparative Example | | | |
|---|---|---|---|---|---|---|---|
| | 1 | 2 | 3 | 1 | 2 | 3 | 4 |
| Melting temperature (° C.) | 237 | 236 | 236 | 237 | 235 | 235 | 236 |
| Glass transition temperature (° C.) | 95 | 96 | 95 | 95 | 96 | 97 | 94 |
| Intrinsic viscosity (dL/g) | 1.2 | 1.18 | 1.19 | 1.2 | 1.22 | 1.03 | 1.21 |
| WVTR (g · mm/m² · day) | 2.21 | 2.35 | 2.31 | 3.34 | 2.34 | 3.24 | 2.31 |
| OTR (cc · mm/m² · day) | 0.5905 | 0.5465 | 0.616 | 0.855 | 0.6225 | 0.7725 | 0.667 |
| Gel content (%) | 0.41 | 0.21 | 0.13 | 0.82 | 0.57 | 0.41 | 0.97 |
| Amount of phosphorus (ppm) | 88 | 58 | 0 | 94 | 75 | 0 | 601 |
| Amount of Na (ppm) | 69 | 50 | 0 | 75 | 57 | 0 | 401 |

From the results, it can be seen that the polyamide resin according to the present invention exhibits excellent heat resistance and processability and can reduce or prevent gel generation upon polymerization or molding.

In contrast, it can be seen that, since the polyamide resins of Comparative Examples 1 to 3 have a high thermal history upon melt polymerization even though the same amount of the catalyst is used, as compared with those of the flash process according to the present invention, the polyamide resins of Comparative Examples 1 to 3 have increased gel content. In particular, it can be seen that, when temperature is increased to improve processability upon melt polymerization without catalysts (Comparative Example 3), the polyamide resin suffers from significant deterioration in molecular weight (intrinsic viscosity) due to side reactions. In addition, it can be seen that, when the amount of the catalyst is increased above the range according to the present invention (Comparative Example 4), the polyamide resin suffers from significant increase in gel content due to increase in amounts of phosphorus and sodium. The presence of such gel content can influence water vapor transmission rate and oxygen transmission rate due to pores and the like caused thereby during film formation using the polyamide resin according to the present invention.

Many modifications and other embodiments of the invention will come to mind to one skilled in the art to which this invention pertains. Therefore, it is to be understood that the invention is not to be limited to the specific embodiments disclosed and that such modifications and other embodiments are intended to be included within the scope of the appended claims.

What is claimed is:

1. A polyamide resin being a polymer of an adipic acid-containing dicarboxylic acid component and an m-xylenediamine-containing diamine component,
wherein the polymer comprises about 100 ppm or less of phosphorus and about 100 ppm or less of sodium, and has a gel content of about 0.5% or less, as measured on a specimen prepared by melting about 10 g of the polymer at about 260° C., maintaining the molten polymer for about 30 minutes, and then cooling the molten polymer to room temperature.

2. The polyamide resin according to claim 1, wherein the polyamide resin has a water vapor transmission rate (WVTR) of about 0.5 g·mm/m²·day to about 3.0 g·mm/m²·day as measured in accordance with ASTM F1249, and an oxygen transmission rate (OTR) of about 0.1 cc·mm/m²·day to about 1.0 cc·mm/m²·day as measured in accordance with ASTM D3985.

3. The polyamide resin according to claim 1, wherein the polyamide resin comprises an end group encapsulated with an end capping agent comprising an aliphatic carboxylic acid, an aromatic carboxylic acid, or a mixture thereof.

4. A method for preparing a polyamide resin, comprising:
preparing a solution-state prepolymer by condensation polymerization of an adipic acid-containing dicarboxylic acid component and an m-xylenediamine-containing diamine component at a temperature of about 200° C. to about 300° C. and at a pressure of about 10 bar to about 40 bar;
forming prepolymer particles by removing a solvent from the solution-state prepolymer by spraying the solution-state prepolymer into a flash evaporator at a temperature of about 15° C. to about 30° C. and at a pressure of about 0 bar to about 3 bar; and
performing solid state polymerization of the prepolymer particles.

5. The method according to claim 4, wherein condensation polymerization is performed in the presence of about 0.05 parts by weight or less of a phosphorus catalyst based on about 100 parts by weight of the dicarboxylic acid component and the diamine component.

6. The method according to claim 4, wherein the flash evaporator comprises a nozzle at a lower side thereof, and the solution-state prepolymer is sprayed upwards into the flash evaporator through the nozzle.

7. The method according to claim 4, wherein the solution-state prepolymer has an intrinsic viscosity of about 0.05 dL/g to about 0.25 dL/g.

8. The method according to claim 4, wherein the solution-state prepolymer is sprayed at a rate of about 10 m/sec to about 70 m/sec.

9. The method according to claim 4, wherein the flash evaporator has a height of about 3 m to about 30 m and a volume of about 1 m³ to about 20 m³.

10. The method according to claim 4, wherein the prepolymer particles have an intrinsic viscosity of about 0.05 dL/g to about 0.25 dL/g and a weight average molecular weight of about 500 g/mol to about 3,000 g/mol.

11. The method according to claim 4, wherein solid state polymerization is performed by heating the prepolymer particles to a temperature of about 150° C. to about 280° C.

12. A molded article formed from the polyamide resin according to claim 1.
